(19) United States
(12) Patent Application Publication
(10) Pub. No.: US 2003/0108785 A1
(43) Pub. Date: Jun. 12, 2003

(54) Meso-porous carbon and hybrid electrodes and method for producing the same

(76) Inventors: L. W. Wu, Auburn, AL (US); Wen-Chiang Huang, Auburn, AL (US)

Correspondence Address: Wen-Chiang Huang, 2076, S. Evergreen Dr., Auburn, AL, 36830, US

(21) Appl. No.: 10/006,515

(22) Filed: Dec. 10, 2001

(51) Int. Cl. C01B 31/02; H01M 4/96; H01M 4/88; H01M 4/58

(52) U.S. Cl. 429/44; 502/101; 423/445 R; 429/231.8

(57) ABSTRACT

A porous carbon-based electrode and a method for producing such an electrode according to a predetermined, two-dimensional or three-dimensional porous template. The method includes the steps of: (A) preparing a porous template by taking the sub-steps of (i) dissolving a first material in a volatile solvent to form an evaporative solution, (ii) depositing a thin film or lamina of this solution onto a substrate, and (iii) exposing this solution film to a moisture environment while allowing the solvent of the solution to evaporate for forming the template, which is a lamina constituted of an ordered array of micrometer- or nanometer-scaled air bubbles being surrounded with walls made of the first material; and (B) operating material treatment means to convert the first material into a carbonaceous material by which meso-scaled pores are also produced in the bubble walls. The resulting porous carbon electrode can be used in a device such as a fuel cell, ultracapacitor, electrochemical cell, battery, and electrochemical sensor.

### BACKGROUND OF INVENTION

(1) Field of Invention

This invention relates to the fabrication of porous electrodes via a templating approach of utilizing a 2-D or 3-D porous template that is characterized by a uniform distribution of meso- and macro-pores in the size range of 10 nm-20 μm surrounded by meso-porous thin walls. In particular, the present invention relates to a method of producing carbon and carbon-inorganic hybrid electrodes with which the formation of the meso-porous or macro-porous template structure is accomplished by a novel self-assembly formation mechanism of moisture-induced bubbles involving thermo-capillary convection during a solvent evaporation procedure.

(2) Description of Prior Art

The following patent documents are believed to represent the state of the art of the fabrication of nano-porous structures, ultracapacitor electrodes, and, particularly, porous carbon electrodes:

### REFERENCES

1. D. W. Firsich, “Carbon Supercapacitor Electrode Materials,” U.S. Pat. No. 5,993,996 (Nov. 30, 1999).

2. Y. Huang, et al., “Method for and Product of Processing Nanostructure Nitride, Carbonitride and Oxycarbonitride Electrode Power Materials by Utilizing Sol Gel Technology for Supercapacitor applications,” U.S. Pat. No. 6,168,694 (Jan. 2, 2001).

3. W. Bell, et al. “Mesoporous Carbons and Polymers,” U.S. Pat. No. 6,297,293 (Oct. 2, 2001).

4. K. P. Gadkaree, “Method of Producing High Surface Area Carbon Structures,” U.S. Pat. No. 6,156,697 (Dec. 5, 2000).

5. K. P. Gadkaree, et al. “Method of Making Mesoporous Carbon,” U.S. Pat. No. 6,228,803 (May 5, 2001); U.S. Pat. No. 6,248,691 (Jun. 19, 2001).

6. K. P. Gadkaree, et al. “Activated Carbon Electrodes for Electrical Double Layer Capacitors,” U.S. Pat. No. 6,225,733 (May 1, 2001).

7. F. S. Baker, “Highly Microporous Carbon,” U.S. Pat. No. 5,710,092 (Jan. 20, 1998).

8. F. S. Baker, et al. “Highly Microporous Carbon and process of Manufacture,” U.S. Pat. No. 5,965,483 (Oct. 12, 1999).

9. N. Sonobe, “Carbonacious Material for Electrical Double Layer Capacitor and Process for Production Thereof,” U.S. Pat. No. 6,258,337 (Jul. 10, 2001).

10. R. Leung, et al., “Nanoporous Material Fabricated Using a Dissolvable Reagent,” U.S. Pat. No. 6,214,746 (Apr. 10, 2001).

11. K. Lau, et al., “Nanoporous Material Fabricated Using Polymeric Template Strands,” U.S. Pat. No. 6,156,812 (Dec. 5, 2000).

12. S. K. Gordeev, et al., “Method of Producing a Composite, More Precisely Nanoporous Body and a Nanoporous Body Produced thereby,” U.S. Pat. No. 6,083,614 (Jul. 4, 2000).

13. L. Owens, et al., “High Surface Area Meso-porous Desigel Materials and Methods for Their Fabrication” U.S. Pat. No. 5,837,630 (Nov. 17, 1998).

14. L. T. Thompson, Jr. et al., “High Surface Area Nitride, Carbide and Boride Electrodes and Methods of Fabrication Thereof,” U.S. Pat. No. 5,680,292 (Oct. 21, 1997).

15. S. T. Mayer, et al., “Carbon Aerogel Electrodes for Direct Energy Conversion” U.S. Pat. No. 5,601,938 (Feb. 11, 1997).

16. F. P. Malaspina, “Supercapacitor Electrode and Method of Fabrication Thereof,” U.S. Pat. No. 5,079,674 (Jan. 7, 1992).

17. J. D. Verhoeven, et al., “Electrolytic Capacitor and Large Surface Area Electrode Element Therefor” U.S. Pat. No. 5,062,025 (Oct. 29, 1991).

18. M. Boudart, et al., “Methods and Compositions Involving High Specific Surface Area Carbides and Nitrides” U.S. Pat. No. 4,851,206 (July 25, 1989).

19. C. P. Cheng, et al., “Inorganic Oxide Aerogels and Their Preparation” U.S. Pat. No. 4,717,708 (Jan. 5, 1988).

20. M. Boudart, et al., “High Specific Surface Area Carbides and Nitrides” U.S. Pat. No. 4,515,763 (May 1985).

21. T. Muranaka, et al., “Electric Double Layer Capacitor” U.S. Pat. No. 4,327,400 (Apr. 27, 1982).

22. G. von Dardel, et al., “Method of Preparing Silica Aerogel” U.S. Pat. No. 4,327,065 (Apr. 27, 1982).

23. T. J. Lynch, “Metal Oxide Aerogels” U.S. Pat. No. 3,977,993 (Aug. 31, 1976).

24. J. L. Kaschmitter, et al. “Carbon Foams for Energy Storage Devices,” U.S. Pat. No. 5,529,971 (Jun. 25, 1996).

25. R. W. Pekala, “Organic Aerogels from the Sol-gel Polymerization of Phenolic-Furfural Mixtures,” U.S. Pat. No. 5,556,892 (Sep. 17, 1996).

26. M. A. Anderson, et al., “Electrochemical capacitor,” U.S. Pat. No. 5,963,417 (Oct. 5, 1999).

27. S. A. Campbell, et al. “Porous Electrode Substrate for an Electrochemical Fuel Cell,” U.S. Pat. No. 5,863,673 (Jan. 26, 1999).

28. S. A. Campbell, et al. “Electrochemical Fuel Cell Membrane Electrode Assembly with Porous Electrode Substrate,” U.S. Pat. No. 6,060,190 (May 9, 2000).

29. Y. L. Peng, et al. “Method of Making Mesoporous Carbon Using Pore Formers,” U.S. Pat. No. 6,024,899 (Feb. 15, 2000).

Porous solids have been utilized in a wide range of applications, including membranes, catalysts, energy storage, photonic crystals, microelectronic device substrate, absorbents, light-weight structural materials, and thermal, acoustical and electrical insulators. These solid materials are usually classified according to their predominant pore sizes: (i) micro-porous solids, with pore sizes <1.0 nm; (ii) macro-porous solids, with pore sizes exceeding 50 nm (normally up to 500 μm); and (iii) meso-porous solids, with pore sizes intermediate between 1.0 and 50 nm. The term “nano-porous solid” means a solid that contains essentially nanometer-scaled pores (1-1,000 nm) and, therefore, covers “meso-porous solids” and the lower-end of “macro-porous solids”.

One example of porous solids for energy storage applications is in the field of ultracapacitors. Like a battery, an ultracapacitor is an energy storage device. Ultracapacitors are well-known for their ability to store and deliver energy at high power densities, and to be cycled for a large number of times without degradation. By contrast, batteries, although being capable of storing large amounts of energy, function efficiently only at relatively low power densities and could degrade quickly if they are deeply cycled. The characteristics of ultracapacitors make them particularly suitable to meet the power requirements of various emerging technologies, including electric vehicles, electronics (e.g., for use in cellular telephones and digital communications) and clean power (e.g., uninterrupted power sources).

An ultracapacitor typically is composed of at least a pair of electrodes separated by a non-conductive porous separator. The space between the electrodes is filled with an electrolyte, which can be an aqueous or organic-based liquid. Because there are no chemical reactions taking place during the charge/discharge cycle, a capacitor can be cycled many times without degradation, unlike batteries. However, current ultracapacitors are known to be deficient in the energy storage capacity and, therefore, are not commercially viable. One approach to improving the energy storage capacity of ultracapacitors is to optimize the interaction between the electrodes and the electrolyte.

There are four basic types of electrode for ultracapacitor application: (1) Activated carbon or foam represents one type of electrode materials, as disclosed by Mayer, et al. [Ref. 15], Malaspina [Ref. 16], and Muranaka, et al. [Ref. 21]. Typical capacitance obtained from an electric double layer is in the range of 20 to about 40 mF/cm². (2) The second type includes some transition metal oxides such as RuO₂ and IrO₂ that posses pseudo-capacitance. Pseudo-capacitance arise from highly reversible reactions, such as redox reactions, which occurs at or near the electrode surfaces. Capacitance of 150 to about 200 nF/cm² have been observed for RuO₂ films. (3) The third type of electrodes consists of metallic bodies which are mechanically or chemically etched to provide a roughened surface and high specific surface area, as disclosed by Verhoeven, et al. [Ref. 17]. High surface area metal electrodes are limited by electrochemical stability. Metals are generally unstable in an oxidizing environment, therefore their use is limited to the positive, reducing electrode or anode. (4) The fourth type of electrodes includes metal nitride, which is in general conductive and exhibits pseudo-capacitance. For instance, molybdenum nitride exhibits a high energy density.

There are two major categories of electrolytes for double layer capacitor devices: aqueous and organic, each of which has advantages and disadvantages. Aqueous electrolytes such as potassium hydroxide and sulfuric acid have low resistance (0.2 to 0.5 ohms/cm²) and can be charged and discharged very quickly. However, they can only be cycled through a potential range of one volt due to the voltage limits of aqueous electrolytes. This shortcoming has severely limited their energy storage density (which is proportional to voltage squared). This is due to the relation: U=½ CV², where U=the potential energy stored in a capacitor, C=the capacitance, and V=the voltage. Organic electrolytes such as propylene carbonate are known to provide much higher breakdown voltages (up to three volts) and therefore have much greater energy storage densities. However, due to their much higher resistance (1-2 ohms/cm²), they cannot be cycled as quickly. The type of electrolyte that is desirable depends on the nature of the specific application.

The mechanism for double-layer capacitor devices is based on the double-layer capacitance at a solid/solution interface. A double-layer ultracapacitor typically consists of high surface area carbon structures that store energy in a polarized liquid layer. The polarized liquid layer forms at the interface between an ionically conducting liquid electrolyte and an electronically conducting electrode (e.g., a carbon electrode). The separation of charges in the ionic species at the interface (called a double layer) produces a standing electric field. Thus, the capacitive layer, while with a thickness of only a few &Ovalhollow;, has a very large interface area. The larger the area of the interface is, the more energy can be stored. Hence, the capacitance of double-layer capacitor is proportional to the surface area of the electrode.

In ultracapacitors, electrodes having pores smaller than about 2 nm do not exhibit increased capacitance, possibly due to the reason that pores smaller than about 2 nm are too small to allow entry of most nonaqueous electrolytes and therefore cannot be fully wetted or accessed. As a result, a portion of the potential interface area is not realized. On the other hand, too large a pore size (e.g., greater than 10 μm) implies too small a surface area Hence, meso-porous materials are believed to be optimal for use in an ultra-capacitor.

Although some carbon electrodes having pore sizes in the meso-porous range have been extensively investigated for use in ultracapacitors due to their low cost and potential for high-energy storage densities, none of them have proved entirely satisfactory. Considering that the capacitance of the material increases linearly with the specific surface area, one would expect a carbon material with a capacitance of 20 μF/cm²) and a surface area of 1,000 m²/g to have a capacitance of 200 F/g if all of the surface were electrochemically accessible. However, since high surface area porous carbons typically have a high fraction of micro-pores (<2 nm), only a fraction of the surface of the carbon is effectively utilized. Most of the surface therefore does not contribute to the double-layer capacitance of the electrode and the measured capacitance values of carbon structures produced by prior-art methods are therefore only about 20% of the theoretical value. For the performance of ultracapacitors to approach the theoretical limit, they should have a high pore volume (>50%) and a high fraction of continuous pores with diameters of greater than 2 nm to allow the electrolyte access to the electrode material surface.

A promising approach to the fabrication of a porous electrode involves the preparation of a macro-porous or meso-porous template. A number of methods have previously been used to fabricate macro- or meso-porous templates, although not intended for the production of electrodes. For instance, meso-porous solids can be obtained by using surfactant arrays or emulsion droplets as templates. Latex spheres or block copolymers can be used to create silica structures with pore sizes ranging from 5 nm to 1 μm. These techniques have not been applied to the fabrication of carbon electrodes.

Kaschmitter, Pekala, and co-workers [Ref. 24,25] disclosed a high energy density capacitor incorporating a variety of carbon foam electrodes. The foams were derived from the pyrolysis of resorcinol-formaldehyde and related polymers. The pore sizes in these electrodes were approximately 0.1 μm. Baker and co-workers [Ref. 7,8] disclosed a porous, highly activated carbon, which was prepared by further chemical activation of activated carbon. This highly activated carbon was intended for use in the adsorption of gaseous hydrocarbon fuels. Firsich [Ref. 1] provided a method of producing carbon electrodes for ultracapacitor application. The method entails forming a thin layer of phenolic resin powder or phenolic resin-carbon powder mixture, which was carbonized, hydrogenated, and sulfonated. This is a slow and complicated process that is not commercially viable. Peng, et al. [Ref. 29] prepared a mesoporous carbon by mixing a carbon precursor with a pore former. The carbon precursor was cured, carbonized, and activated and, at the same time, the pore former was removed. A similar method was disclosed by Gadkaree, et al. [Ref. 4-6] who prepared a meso-porous carbon electrode by mixing a high carbon-yielding precursor and low carbon-yielding precursor and then curing, carbonizing, activating the resulting mixture to produce a meso-porous material. Bell, et al. [Ref. 3] prepared a meso-porous material by polymerizing a resorcinol/formaldehyde system from an aqueous solution containing resorcinol, formaldehyde and a surfactant. The cured polymer was pyrolyzed to form a carbonaceous material.

One approach to fabrication of high surface area electrodes involves consolidation of very fine powders. This approach is complicated by the difficulty of controlling particle size and surface contamination. In addition, particle aggregation can lead to difficulties in processing of the materials. It has been found that the electrical performance of devices based on consolidated powders is often limited by inter-particle electrical resistance, and this requires the addition of conductivity enhancing additives or specialized processing steps.

In summary, the major drawbacks of the carbons used in current double-layer ultracapacitors are: low capacitance (due to pores that are too large or too small) and high costs (due to materials and processing costs). Furthermore, the low electrical conductivity (due to high resistance at particle/particle interfaces) of a fine particle-derived electrode itself affects the efficiency of the capacitor. Thus, for ultracapacitor electrodes, monolithic carbon or carbon-inorganic hybrid is more desirable than particulate carbons or compacts of carbon particles. The latter have high surface areas, but suffer from high internal resistance because of the inter-particle interfaces. Despite the availability of previous methods for preparing nano-porous materials, an urgent need exists for further improvements in both nano-porous carbon materials and methods for preparing the same. In particular, there remains a need for new methods which eliminate some or all of the aforementioned problems, such as providing methods for making nano-porous films of sufficient mechanical strength that are also optimized to have a desirable 2-D or 3-D array of nano-sized pores dispersed in a carbon material.

In the present invention, insofar as it pertains to porous electrode materials, is an improvement over the prior art in that it allows nanometer-scale pores to readily form in the walls of the air bubbles in a template, which is constituted of an ordered 2-D or 3-D array of air bubbles in a polymer film. The bubbles can be made into sizes within the range of 20 nm-20 μm in diameter, but preferably within the range of 20 nm-1,000 nm in diameter. The polymer, which makes up the bubble walls, is then converted into carbon. During this conversion process (e.g., through material treatment means such as a simple pyrolization or combined chemical etching-pyrolization), the polymer walls become meso-porous or nano-porous. The needed 2-D or 3-D templates can be mass-produced at a very high rate. The present invention is simpler, does not require a complicated apparatus, and is flexible in terms of selecting the template matrix material which is a carbon precursor.

### SUMMARY OF THE INVENTION

One embodiment of the present invention is a method for producing a meso-porous electrode according to a predetermined, two-dimensional or three-dimensional porous template. This method includes five steps. The first step, Step (A), entails preparing a nano-porous template, wherein the preparation step includes three sub-steps: (i) dissolving a first material (e.g., a polymer, oligomer, or non-polymeric organic substance) in a volatile solvent to form an evaporative solution, (ii) depositing a thin film of this solution onto a substrate, and (iii) directing a moisture-containing gas to flow over the spread-up solution film while allowing the solvent in the solution to evaporate for forming a template, which is constituted of an ordered array of micrometer- or nanometer-scaled air bubbles surrounded with walls of the first material. This template can be a 2-D or single layer (lamina) of orderly dispersed bubbles, or a 3-D or multiple layers (laminas) of orderly dispersed bubbles, depending on the processing conditions to be specified at a later section.

Step (A) is followed by step (B), which entails converting the material in bubble walls to a partially carbonized or fully carbonized material, hereinafter referred to as a carbonaceous material, by performing a material treatment (e.g., including pyrolization). During such a material treatment step, the walls themselves, which are composed of the first material, naturally become micro- and/or nano-porous, pore sizes typically lying in the range of 1 nm to 20 nm. Micro-porous carbonaceous walls with pore sizes smaller than 2 nm may be optionally subject to an activation treatment to further open up the pores so that electrolytes can have access to more electrode surface areas. The wall pores may be optionally coated with an electronically conductive polymer or inorganic material (e.g., NiO and/or Ni).

Another embodiment of the present invention involves a similar method, but the template prepared in Step (A) was coated with a carbon precursor material prior to the carbonization step. This second material coated on the walls of the air bubbles are preferably selected from a high carbon-yield material. This second material provides the needed carbon content after pyrolization provided that the first material exhibits a low carbon content. After pyrolization, the resulting porous structure may be subjected to a coating treatment with a third material (e.g., RuO₂, NiO, Ni, etc.), which is electronically conductive.

Advantages of the Present Invention

1. The templates can be mass-produced using a simple procedure and no expensive or complicated equipment is required. The over-all procedure is simple and easy to accomplish and, hence, is cost-effective. The formation of templates by using the current approach is faster and simpler than other template preparation techniques such as emulsion templating and co-polymer templating.

2. Both 2-D and 3-D templates, with air bubble sizes ranging from nanometer to micrometer scales, can be readily made and, therefore, both 2-D and 3-D electrodes can be fabricated using the presently invented method.

3. A wide variety of materials can be used as a bubble wall material or a second material coated on the bubble walls, which can be converted to become carbonaceous materials. Once the carbonaceous materials are formed, a wide scope of organic or inorganic compositions can be used as the bubble wall coating materials to make a hybrid electrode. Hence, an extremely wide range of electrodes can be readily fabricated to meet a great array of applications.

### BRIEF DESCRIPTION OF THE DRAWINGS

FIG. 1 A flowchart showing the essential steps of a method for producing meso-porous electrodes in accordance with three preferred embodiments of the present invention.

FIG. 2 A micrograph showing an example of a polystyrene-based template that contains pores (air bubbles) surrounded by polystyrene walls.

### DETAILED DESCRIPTION OF PREFERRED EMBODIMENTS

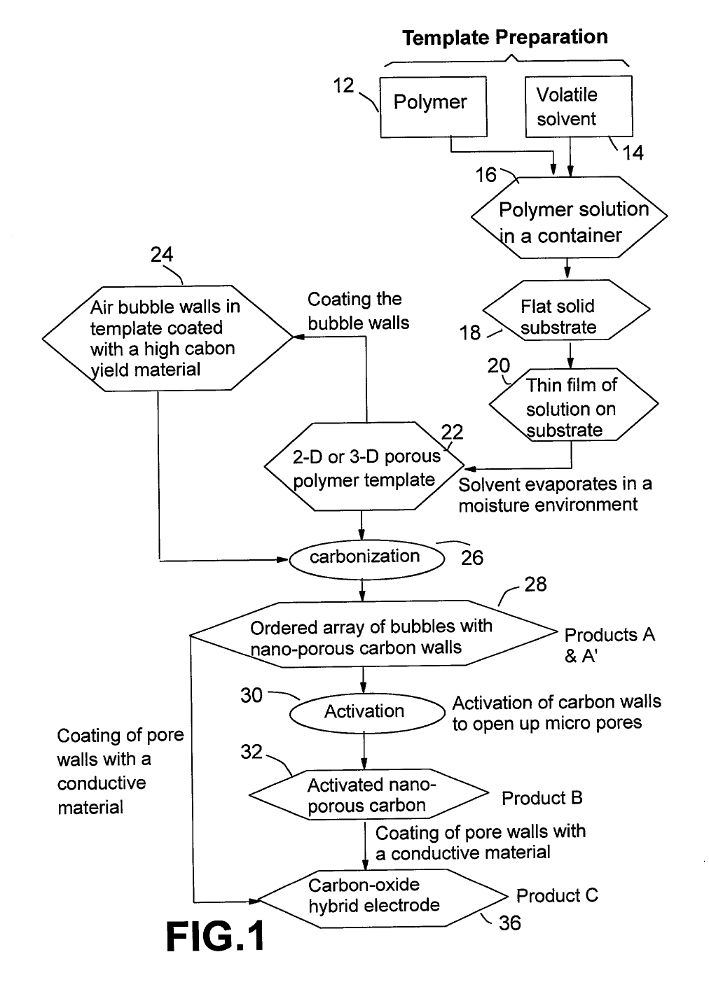

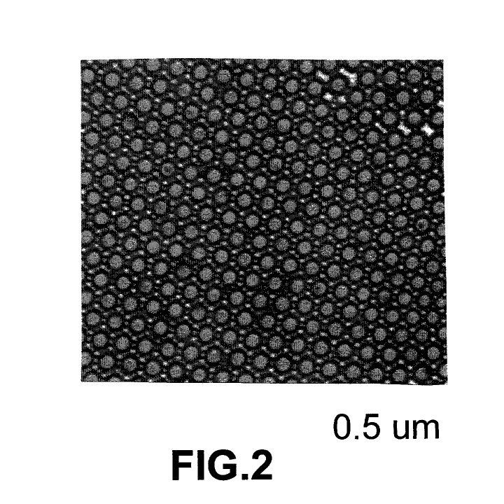

A preferred embodiment of the present invention is a method for producing an electrode according to a predetermined, two-dimensional or three-dimensional nano-, meso-, or macro-porous template made of a first material. The first step, Step (A), of this method involves the preparation of a porous template from the first material (preferably a polymer, but can be an oligomer or non-polymeric organic substance). Step (A) includes several sub-steps (FIG. 1): (i) dissolving the first material (e.g., a polymer 12) in a volatile solvent 14 to form an evaporative solution 16; (ii) depositing a thin film of this solution onto a substrate 18 (e.g., the surface of a casing material for an ultracapacitor), and (iii) exposing the solution film 20 on the substrate to a moisture environment (e.g., by directing a moisture-containing gas to flow over this solution film) while, concurrently and/or subsequently, allowing the solvent in this solution to rapidly evaporate for forming a template 22. The template is constituted of an ordered array of micrometer- or nanometer-scaled air bubbles with polymeric walls dispersed in a polymer film (e.g., FIG. 2) if the first material is a polymer.

The preparation of a nano-porous polymer template is similar to the procedures used by M. Srinivasarao, et al. (Science, vol. 292, Apr. 6, 2001, pp. 79-83), G. Widawski, et al. (Nature, vol. 369, Jun. 2, 1994, pp. 387-389), and O. Pitois and B. Francois (Eur. Physical Journal, B8, 1999, pp. 225-231). The polymers that can be used in practicing the present patent includes simple coil type polymers (e.g., linear polystyrene), star-shaped polymers (e.g., star-polystyrene), and rod-coil copolymers (e.g., polyparaphenylene-polystyrene block copolymer). A wide range of solvents can be used to dissolve these polymers, including benzene, toluene, and carbon disulfide (CS₂). We have found that low molecular weight polymers (oligomers) and some non-polymeric organic substances may also be used to create a template.

A thin layer of the prepared solution is deposited onto a flat substrate, e.g., via coating of the substrate by spin-coating, spray-coating, or dip-coating. The solvent in this thin layer of solution is allowed to rapidly evaporate in the presence of moisture. Since a large quantity of solution can be sprayed over to cover a large surface area of a substrate, this process can be used as a mass-production method. The procedure may be accelerated by sending a flow of moisture-containing nitrogen gas across the surface of this thin solution layer. In a matter of seconds, the solvent evaporates, leaving behind an ordered array of holes or air bubbles on the solid polymer film surface. These typically spherical holes are organized in a compact hexagonal network with micro-porous polymeric walls separating these spherical holes. We have found that, by manipulating the temperature, moisture level, and gas flow rate, one can vary the pore sizes in a controlled fashion. Although M. Srinivasarao, G. Widawski, O. Pitois, and their respective co-workers have observed that the pore sizes are within the range of 0.20 to 20 μm, we have found that uniformly-sized nano pores with a pore size in the range of 10-1,000 nm are also readily obtainable.

Depending on the relative density of the solvent used with respect to the density of water, the resulting template can be a two-dimensional template comprising one layer of air bubbles dispersed in the first material, or a three-dimensional template comprising multiple layers of air bubbles dispersed in the first material. When a solvent less dense than water is used, such as benzene or toluene, a multi-layer structure or 3-D template results, each layer being composed of a normally hexagonal array of air bubbles. When a solvent denser than water is used, such as carbon disulfide, a single-layer of pores or 2-D template is obtained.

Step (A) is then followed by step (B), which involves operating material treatment means (e.g., pyrolization, 26 in FIG. 1) to convert the first material into a carbonaceous material and to generate meso-scaled pores in the walls to produce the porous carbon electrode 28 (Product A in FIG. 1). According to this invention, by meso-porous carbon walls is meant that at least about 50%, and more typically about 60% to 90% of the total pore volume of the bubble walls is in the range of 2 to 50 nm and no more than 25 percent pore volume is in the range of large pores (>50 nm). A wide range of organic materials can be readily converted into a continuous-structure carbonaceous material, which is composed primarily of carbon atoms (i.e., most of the non-carbon elements such as hydrogen, oxygen, and nitrogen are removed during a heat treatment process (e.g., pyrolyzation). The first material could include a carbon precursor material selected from polymers (thermoplastic and thermoset resins) and non-polymeric substances (e.g., coal tar pitch and petroleum pitch).

The material treatment step could include partial carbonization (with less than approximately 90% of non-carbon elements being removed) or full carbonization (greater than 90% of non-carbon elements removed) by heat. The carbonization or partial carbonization sub-step may be preceded by a sub-step of removing a portion of the first material via chemical etching or dissolution to create additional pores. Partial carbonization or carbonization is known to generate meso-scaled pores due to the fact that non-carbon elements are cleaved from carbon atoms during the thermal degradation process and the degradation-induced by-products such as CO, CO₂, H₂O, O₂, N₂, and other volatile chemical species originally residing in the carbon precursor material must somehow find a way to escape. The removal of these species typically leads to the formation of nanometer-scaled pores in the air bubble walls.

When the carbon precursor is a thermosetting resin, the carbon precursor is cured prior to carbonization. The curing is accomplished typically by heating the precursor to temperatures of about 100° C. to about 200° C. for about 0.5 to about 5.0 hours. Curing is generally performed in air at atmospheric pressures. When using certain precursors, (e.g., furfuryl alcohol) curing can be accomplished by adding a curing catalyst such as an acid catalyst at room temperature. In the case of a resin containing a metal compound catalyst (e.g., for the purpose of activating the carbon after pyrolization), the curing also serves to retain the uniformity of the metal compound catalyst distribution in the carbon.

As indicated earlier carbonization is the thermal decomposition of the carbon precursor material, thereby eliminating low molecular weight species (e.g., carbon dioxide, water, gaseous hydrocarbons, etc.) and producing a fixed carbon mass and a pore structure in the carbon. The pores in the carbonaceous walls are typically in the size range of 1 nm to 10 nm. Such conversion or carbonization of the cured carbon precursor is accomplished typically by heating to a temperature in the range of about 400° C. to about 800° C. for about 1 to about 4 hours in a reducing or inert atmosphere (e.g., nitrogen, argon, helium, etc.).

Curing and carbonizing the carbon precursor results in substantially uninterrupted carbon with uniformly dispersed catalyst particles (if present) in a carbon body. The catalyst usually is aggregated into larger particles, different from the cured structures, where catalyst is molecularly dispersed. The size of the catalyst particle depends on the catalyst amount added to the starting resin. The more catalyst in the initial resin, the higher tendency for the catalyst particles to aggregate.

Curing and carbonizing the catalyst metal compound in the carbon precursor results in uniform and intimate chemical bonding of catalyst with uninterrupted carbon structure. The resulting catalyst particle size, controlled by catalyst loading, process parameters, and nature of catalyst, etc., is a primary factor to determine pore sizes in the activated carbon. Well-dispersed and uniform catalyst particle size can help to develop meso-pores in the activated carbon in the latter activation step.

Step (B) of the presently invented method may be followed by an additional step 30 of activating the porous carbon walls, provided the carbon walls have a significant amount of pores that are smaller than 5 nm. The activation of carbon walls is done in a catalytic way to substantially create new porosity in the meso-pore size range, as well as to enlarge the diameter of the micro-pores formed and therefore to increase the pore volume. This step results in the formation of a highly desirable activated nano-porous carbon electrode 32 (Product B in FIG. 1) with proper pore sizes. In general, activation can be carried out by standard methods, in carbon dioxide or steam at about 400-900° C. If activation is in steam, the temperatures are preferably about 400° C. to about 800° C.

After Step (B), the method may further include a step of impregnating or coating the meso-porous bubble walls with a separate material to form a carbon hybrid electrode 36 (Product C in FIG. 1). This separate material is preferably an electronically conductive material such as a conductive polymer (e.g., polypyrrole), a metal (e.g., lithium, if for lithium battery applications), or an oxide (e.g., VOₓ, IrOₓ, RuOₓ and NiO where x is typically 2). Ruthenium oxide (RuO₂) was found to be particularly attractive for ultracapacitor applications due to its high surface electron conductivity.

An alternative version of the method for producing a porous carbon electrode according to a predetermined, two-dimensional or three-dimensional porous template include the following steps: (A) preparing a porous template, following a similar sequence of steps as described above; (B) impregnating the air bubbles in the template with a second material so that the bubble walls are coated with a layer of this second material (24 in FIG. 1); and (C) operating material treatment means (e.g., pyrolization 26) to convert the first and/or second material into a carbonaceous material and to generate meso-scaled pores in the walls to produce the porous carbon electrode

### Product A′ in FIG. 1

The primary reason for coating the first material with a second material is to extend the applicability range of the presently invented method. The original wall material is normally a polymer, oligomer (low molecular weight version of a polymer), or a non-polymeric organic substance which does not necessarily have the desired high carbon yield characteristic for a specific application. This first material may be coated with a second material which is a carbon precursor capable of producing a high carbon yield when this precursor is subjected to a heat treatment (e.g., pyrolization). By high-yielding carbon precursor is meant that on curing, the precursor yields greater than about 40% of the cured resin is converted to carbon on carbonization. For purposes of this invention, an especially useful high-yielding carbon precursor is a synthetic polymeric carbon precursor, e.g. a synthetic resin in the form of a solution or low viscosity liquid at ambient temperatures or capable of being liquefied by heating or other means. Synthetic polymeric carbon precursors include any liquid or liquefiable carbonaceous substances. Examples of useful carbon precursors as the second material in this version of the invented method include thermosetting resins and some thermoplastic resins.

Where the carbon precursor used as a second material in the present version of the method is in the form of a coating, the resulting carbon coating after pyrolization is anchored into the porosity of the air bubble walls and as a result is highly adherent. The top surface of the carbon coating is an uninterrupted layer of carbon to carbon bonds. If interconnecting porosity is present in the walls, an interlocking network of carbon will be formed within the composition, resulting in an even more adherent carbon coating. The coating of uninterrupted carbon extending over the outer surface of the bubble walls formed provides a structure with advantages of high catalytic capability despite a relatively low carbon content, high strength, and high use temperatures. Structures can be formed which contain carbon in an amount less than and up to about 50%, often less than and up to about 30% of the total weight of the walls.

The method may further include a step of impregnating or coating the air bubbles and/or meso-scaled pores in the bubble walls with a third material to form a carbon hybrid electrode 36. This third material is preferably an electronically conductive material such as a conductive polymer (e.g., polypyrrole), a metal (e.g., lithium, if for lithium battery applications), or an oxide (e.g., VOₓ, IrOₓ, RuOₓ and NiO where x is typically 2). Again, ruthenium oxide (RuO₂) was found to be particularly attractive for ultracapacitor applications due to its high surface electron conductivity.

In the above three embodiments of the presently invented method, in order to produce a thicker 3-D porous electrode, one may choose to prepare a thicker 3-D template by repeating sub-steps (A-ii) and (A-iii). Specifically, one can deposit a thin film of this solution onto a substrate, which is exposed to a moisture environment (e.g., by directing a moisture-containing gas to flow over this solution film) while allowing the solvent in this solution to rapidly evaporate for forming a first lamina of a template. This sub-step is followed by deposition of a second layer of solution film onto the first layer to form a second lamina of the template when the solvent in the second layer is vaporized. These sub-steps are repeated until a desired number of laminas are stacked together to form a thick, 3-D template. Since the second and subsequent layers are of identical chemical compositions to the same layer, there is excellent chemical compatibility between layers, resulting in the formation of an integral 3-D template. This thick, 3-D template is then subjected to the carbonization and porosity-generating treatments to produce an electrode. Alternatively, during the above repetitive template preparation process, one may choose to intermittently heat-treat a lamina or a selected number of laminas prior to the deposition of a successive template lamina.

In the above three embodiments of the presently invented method, the step of carbonization may be preceded with a step of chemical or solvent etching of the first material to produce a desired amount of minute pores in the bubble walls. This is one way to create the nano-pores without having to go through activation after carbonization.

Another embodiments of the present invention are the electrodes and electrode materials prepared by the above two versions of the invented method. Each of these materials can be used as a primary electrode material in an electrochemical capacitor, ultracapacitor, fuel cell, battery, or electrochemical sensor.

### EXAMPLE 1

A multi-layer macro-porous template was prepared from a polyparaphenylene-polystyrene block copolymer on a glass substrate by repeated solution coating and solvent removal procedures. Depending upon the moisture levels, solvent content, and solvent vaporization temperature, the air bubbles were found to vary in size from 500 nm to 10 μm. A sample with an average bubble size of 3.4 μm was carbonized at 750° C. for 1 hour. The bubble walls of the resulting sample after carbonization became both micro-porous (approximately 60% of pores with a size <2 nm) and meso-porous (40% of pores >2 nm in size, mostly between 2 nm and 5 nm).

### EXAMPLE 2

A polystyrene template was prepared by casting a polystyrene-benzene solution onto a glass substrate. The air bubbles were found to be approximately 2 μm in diameter. This template was dip-coated with a low viscosity phenolic resin so that the bubble walls (made up of polystyrene or the first material) was coated with a second material (phenolic resin). Phenolic resin was known to have a much higher carbon yield when pyrolized than polystyrene. The phenolic resin-coated template was then dried at 95° C., cured at 150° C., and carbonized at 750° C. for various time periods. Percent pores were determined on a volume basis using nitrogen adsorption. The percent pore volume in the micro-pore range was determined using the standard t-method. Percent meso-pore volume was determined using the BJH method. The resultant activated carbons feature mainly the characteristics of micro-porous carbons. Greater than about 60% of pore volume in the bubble walls is in the micro-pore range (<2 nm). Surface areas are at least above 800 m²/g carbon.

### EXAMPLE 3

The same sample as obtained by Example 2, but subjected to an activation treatment, which involved a temperature of 900° C. in a CO₂ atmosphere for 20 minutes. Less than 30% of pore volumes in the bubble walls is in the micro-pore range. Most of the pores are meso-porous.

### EXAMPLE 4

This example involved a catalyzed activation process where ferric nitrate was used as the catalyst metal. About 7 g of ferric nitrate was added to a small amount of water. After it was completely dissolved, the solution was mixed into about 1,000 ml of phenolic resole resin (same resin as Examples 2 and 3) and stirred vigorously to ensure homogeneous dispersion of the catalyst precursor. The metal-containing mixture was used to dip-coat a polystyrene template. The phenolic resin-coated template was then dried at 95° C., cured at 150° C., carbonized at 750° C. for about 1 hr in nitrogen, and activated at about 700° C. for a period of 1 hour in steam and nitrogen mixture. The resulting sample of activated carbon walls was analyzed using nitrogen adsorption isotherm for pore size distribution. The resulting activated carbon walls were found to be mainly meso-porous, the meso-porous content being 80-90% of the total porosity. The carbon walls had about 10% of micro-pores and macro-pores. The majority of pores in the meso-pore range is around 3 to 6 nm (85% of meso-pores). The surface area of the meso-porous carbon walls ranges from 500 to 650 m²/g carbon. A significant drop in the proportion of micro-pores in the catalyst-assisted activation was observed due to the addition of catalysts.

### EXAMPLE 5

A sample prepared by the steps described in Example 1 was subjected to a coating treatment. The carbonaceous bubble walls was further coated with nickel oxide/nickel to make a carbon/nickel oxide/nickel electrode. The coating solution was prepared from nickel acetate. Nickel acetate tetrahydrate was dehydrated at approximately 100° C. Approximately 10 grams of this dried powder was added to 120 ml Milli-Q water and stirred for 24 hours. The precipitate was separated by centrifugation and re-suspended in 10 ml of Milli-Q water to produce a sol, which was used to dip-coat the carbonaceous template having meso-porous bubble walls. Cyclic voltammetry studies using these electrodes in a 1 M KOH electrolyte solution have indicated a differential capacitance of about 64 F/g. The specific energy and specific power of this sample were about 35 kJ/kg and 11 kW/kg, respectively.

1. A method for producing a porous carbon electrode according to a predetermined, two-dimensional or three-dimensional porous template, the method comprising the steps of:
(A) preparing said porous template, wherein said preparation step comprises the sub-steps of (i) dissolving a first material in a volatile solvent to form an evaporative solution, (ii) depositing a thin film or lamina of said solution onto a substrate, and (iii) exposing said solution film to a moisture environment while allowing the solvent of said solution to evaporate for forming said template which is a lamina constituted of an ordered array of micrometer- or nanometer-scaled air bubbles which are surrounded with walls made of said first material; and
(B) operating material treatment means to convert said first material into a carbonaceous material and to generate meso-scaled pores in said walls to produce said porous carbon electrode.

2. The method of claim 1, wherein step (B) comprises a sub-step of partially or fully carbonizing said first material by heat.

3. The method of claim 1, wherein step (B) comprises sub-steps of (B-i) removing a portion of said first material via chemical etching or dissolution and (B-ii) partially or fully carbonizing said first material by heat.

4. The method of claim 1, further including a step of impregnating or coating said bubbles and/or meso-scaled pores in said bubble walls with a second material to form a carbon hybrid electrode.

5. A method for producing a porous carbon electrode according to a predetermined, two-dimensional or three-dimensional porous template, the method comprising the steps of:
(A) preparing said porous template, wherein said preparation step comprises the sub-steps of (i) dissolving a first material in a volatile solvent to form an evaporative solution, (ii) depositing a thin film or lamina of said solution onto a substrate, and (iii) exposing said solution film to a moisture environment while allowing the solvent of said solution to evaporate for forming said template which is a lamina constituted of an ordered array of micrometer- or nanometer-scaled air bubbles which are surrounded with walls made of said first material;
(B) impregnating said air bubbles with a second material so that the bubble walls are coated with said second material; and
(C) operating material treatment means to convert said first and/or second material into a carbonaceous material and to generate meso-scaled pores in said walls to produce said porous carbon electrode.

6. The method of claim 5, further including a step of impregnating or coating said air bubbles and/or meso-scaled pores in said walls with a third material to form a carbon hybrid electrode.

7. The method of claim 1, 4, or 5 wherein sub-step (A-iii) is performed by directing a moisture-containing gas to flow over said solution film while allowing the solvent of said solution to evaporate for forming said porous template.

8. The method of claim 1, 4, or 5 wherein said first material is selected from the group consisting of a polymer, oligomer, and non-polymeric organic material.

9. The method of claim 8 wherein said polymer is selected from the group consisting of a thermoplastic resin, a thermoset resin, or a combination thereof.

10. The method of claim 5 wherein said second material is selected from the group consisting of a thermoplastic, a thermoset resin, a petroleum pitch, a coal tar pitch, or a combination thereof.

11. The method of claim 4 wherein said second material is an electronically conductive material selected from the group consisting of a polymer, a non-polymeric organic, a metal, an oxide, or a combination thereof.

12. The method of claim 5, wherein step (C) comprises a sub-step of partially or fully carbonizing said first and/or second material by heat.

13. The method of claim 5, wherein step (C) comprises sub-steps of removing a portion of said first and/or second material via chemical etching or dissolution, and of partially or fully carbonizing said first and/or second material by heat.

14. The method of claim 6 wherein said third material is an electronically conductive material selected from the group consisting of a polymer, a non-polymeric organic, a metal, an oxide, or a combination thereof.

15. The method of claim 1 or 5 wherein said template is a two-dimensional lamina comprising one layer of air bubbles dispersed in said first material.

16. The method of claim 1 or 5 wherein said template is a three-dimensional template lamina comprising multiple layers of air bubbles dispersed in said first material.

17. An electrode material patterned according to a predetermined, two-dimensional or three-dimensional template, produced according to the method of claim 1 or 5.

18. The method of claim 1 or 5, wherein the sub-step (A-ii) of depositing a thin film of said solution onto a substrate comprises a sub-step of coating said substrate by spin-coating, spray-coating, or dip-coating.

19. The product of claim 1 or 5, used as an electrode in a device selected from the group consisting of a fuel cell, an ultracapacitor, an electrochemical cell, a battery, and an electrochemical sensor.

20. The method of claim 1 or 5, wherein sub-steps (A-ii) and (A-iii) are repeated a predetermined number of times to form a multi-lamina template, wherein a thin film of solution is deposited onto a preceding film after the solvent in the preceding film has been partially or completely evaporated to form a thick lamina.

21. The method of claim 20, wherein the wall material in a lamina or a number of laminas is at least partially carbonized before a successive film solution is deposited.

22. The method of claim 1 or 5, further comprising a step of activating said carbonaceous material.
